(19) United States
(12) Patent Application Publication
(10) Pub. No.: US 2008/0126743 A1
(43) Pub. Date: May 29, 2008

(54) Reducing Stalls in a Processor Pipeline

(75) Inventor: Zihno Jusufovic, Arlington, TX (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Hsin-Tien (TW)

(21) Appl. No.: 11/462,469

(22) Filed: Aug. 4, 2006

Related U.S. Application Data
(60) Provisional application No. 60/807,620, filed on Jul. 18, 2006.

(51) Int. Cl. G06F 9/30; G06F 15/78

(52) U.S. Cl. 712/1; 712/220; 712/E09.016

(57) ABSTRACT

Systems and methods are disclosed herein for processing instructions in a processor pipeline to reduce the number of stalls therein. In an exemplary embodiment, a processor pipeline comprises a fetch stage configured to fetch instructions to be processed in the processor pipeline, a decode stage configured to decode the fetched instructions, and an execute stage configured to execute the decoded instructions. The decode stage may be configured to store instructions in a temporary buffer before the instructions are decoded. With this general structure, the decode stage can further stall the fetch stage if the execute stage detects an error caused by a change in the operational mode of the processor pipeline. An error may result, for example, when one or more registers being used in a current operational mode are determined to be inaccessible in a new operational mode.

### CROSS-REFERENCE TO RELATED APPLICATIONS

The present application claims the benefit of provisional application Ser. No. 60/807,620, filed Jul. 18, 2006.

### TECHNICAL FIELD

The present disclosure generally relates to processors and more particularly relates to systems and methods for reducing the number of stalls in a processor pipeline to increase processor performance.

### BACKGROUND

FIG. 1 is a block diagram of a conventional processing circuit 10. The processing circuit 10 may be incorporated, for instance, in a hand-held electronic device, computer system, etc. The processing circuit 10 includes a processor 12, memory 14, and a number of input/output (I/O) devices 16. The processor 12, memory 14, and I/O devices 16 communicate with each other via a bus interface 18. The performance and operational speed of the processor 12 in such a processing circuit 10 impacts the overall power consumption and operating functions of the entire system. Therefore, circuit designers have dedicated much time and effort to improve the speed and performance of the processor 12 by attempting to eliminate various sources of inefficiencies, even inefficiencies in the processor pipeline.

FIG. 2 is a block diagram of a conventional processor pipeline 20 included within the processor 12. In this example, the pipeline 20 has five stages, including a fetch stage 22, a decode stage 24, an execute stage 26, a memory access stage 28, and a write-back stage 30. The processor pipeline 20 has a structure allowing five instructions to be processed simultaneously. The manner in which the pipeline 20 operates can be compared, for example, to an assembly line. For instance, while one stage, such as the fetch stage 22, may be fetching an instruction, another stage, such as the decode stage 24, may be decoding a previously fetched instruction. Each stage of the processor pipeline 20 can perform its intended task(s) on an instruction, pass this instruction down the line to the next stage, and then receive an instruction from a previous stage, etc. In this way, the stages perform their various functions on multiple instructions such that the pipeline 20 as a whole is able to handle multiple instructions simultaneously, which allows a more efficient use of time versus a processor that can operate on only a single instruction at a time. Furthermore, the processor pipeline 20 may include any reasonable number of stages. While some processors may have a simple four-stage pipeline structure, others are known to have up to twenty stages. Generally speaking, processor pipelines typically include at least a fetch stage, a decode stage, an execute stage, a memory access stage, and a write-back stage, as shown, or variations of these main stages.

Another aspect of the processor pipeline 20 to be considered in circuit design is the operational “mode” of the pipeline 20. Typically, the operational modes include a normal mode and a number of interrupt modes, or the like, which are exceptions to the normal mode. Processors may utilize the normal mode in regular situations, but may switch to the other exception modes in response to instructions in the code or based on conditions in the processor.

Furthermore, depending on the selected mode, the processor pipeline 20 utilizes a number of available “registers” for storing data, instructions, and/or addresses during processing. Some of the registers may be utilized regardless of the operational mode, but others may be reserved only for certain modes. Because of the availability of different registers with respect to different modes, it is possible that some registers available in one mode may not be available when the mode is changed. For example, the decode stage 24 may decode an instruction to change modes. However, the decode stage 24 may only be able to detect that a change of mode has occurred, yet it does not know what the new mode is. The decode stage 24 passes along the decoded mode change instruction to the execute stage 26, and the execute stage 26 executes the instruction to effectively change the mode. The execute stage 26 sends an “exec_mode” signal, indicative of the new mode, to the decode stage 24 in order that the two stages will be in the same mode and use the same set of registers. However, for one clock cycle in this case, the decode stage 24 uses the old mode for the next instruction, which will not be synchronized with the new mode calculated in the execute stage 26. If the registers being used in the new instruction involve a register that is not available in the previous mode, or vice versa, then a mode error occurs. Therefore, circuit designers have placed certain logic and/or hardware in the pipeline 20 to avoid these mode change errors. One common technique has been to create a stall condition in the pipeline until the mode change instruction is executed in the execute stage and other stages (from the decode stage up to the execute stage) are made aware of the new mode.

However, not all mode changes actually require the use of different registers. There is a good possibility that the change in mode will not require the use of an inaccessible register. Also, there is good possibility that the change in mode will not require a new set of registers. Since conventional processor pipelines stall the pipeline whenever a mode change is detected, the pipeline is oftentimes stalled unnecessarily. Thus, a need exists in the industry to address the aforementioned deficiencies and inadequacies by detecting whether or not the mode change actually requires the use of an inaccessible register. By adding detection circuitry for detecting mode errors, the number of unnecessary stalls can be reduced.

### SUMMARY

The present disclosure relates to processor pipeline and systems and methods for reducing the number of unnecessary stalls in the pipeline. In a general embodiment, the processor pipeline described herein may comprise a fetch stage, a decode stage, and an execute stage. The fetch stage is configured to fetch instructions to be processed in the processor pipeline, the decode stage is configured to decode the fetched instructions, and the execute stage is configured to execute the decoded instructions. The decode stage is further configured to store instructions in a temporary buffer before the instructions are decoded.

The general processor pipeline may include a decode stage that is further configured to stall the fetch stage when the execute stage detects an error caused by a change in the operational mode of the processor pipeline. The execute stage may detect such an error when one or more registers being used in a current operational mode are determined to be inaccessible in a new operational mode.

In addition, the present disclosure includes, for example, a processor that comprises a pipeline including at least a decode stage and an execute stage. The processor and includes a module, in communication with the decode stage, for temporarily storing instructions. In this example, the decode stage is configured to store a first instruction in the instruction storing module and also decode the first instruction. In this system, the pipeline is capable of processing a number of instructions without stalling, even when a change in the operational mode of the pipeline is detected.

A method is also disclosed herein for processing instructions in a processor pipeline. The method may comprise, for example, decoding an instruction that changes the operational mode of the processor pipeline and storing at least one instruction after the mode change instruction. Also, the method includes detecting whether the mode change instruction causes a mode change error. As further described in the present application, the method may decode, with stalling, at least one instruction after the mode change instruction. However, when a mode change error is detected, the method may include stalling the stage preceding a decode stage and decoding the at least one stored instruction.

Other systems, methods, features, and advantages of the present disclosure will be apparent to one having skill in the art upon examination of the following drawings and detailed description. It is intended that all such additional systems, methods, features, and advantages be included within this description and protected by the accompanying claims.

### BRIEF DESCRIPTION OF THE DRAWINGS

Many aspects of the embodiments disclosed herein can be better understood with reference to the following drawings. It should be noted that like reference characters throughout the figures are meant to designate the same or corresponding elements.

FIG. 1 is a block diagram of a conventional processing system.

FIG. 2 is a block diagram of a conventional processor pipeline.

FIG. 3 is a block diagram of an embodiment of a nine-stage processor pipeline capable of avoiding mode change errors.

FIGS. 4A-4D illustrate an example of the flow of sequential instructions through the processor pipeline of FIG. 3.

FIG. 5 is a block diagram of a preferred embodiment of a nine-stage processor pipeline according to the teachings of the present application.

FIG. 6 is a block diagram of an embodiment of the decode stage shown in the embodiment of FIG. 5.

FIG. 7 is a block diagram of an embodiment of the execute stage shown in FIG. 5.

FIGS. 8A-8D illustrate an example of the flow of sequential instructions through the processor pipeline of FIG. 5 when no mode error is detected.

FIGS. 9A-9F illustrate an example of the flow of sequential instructions through the processor pipeline of FIG. 5 when a mode error is detected.

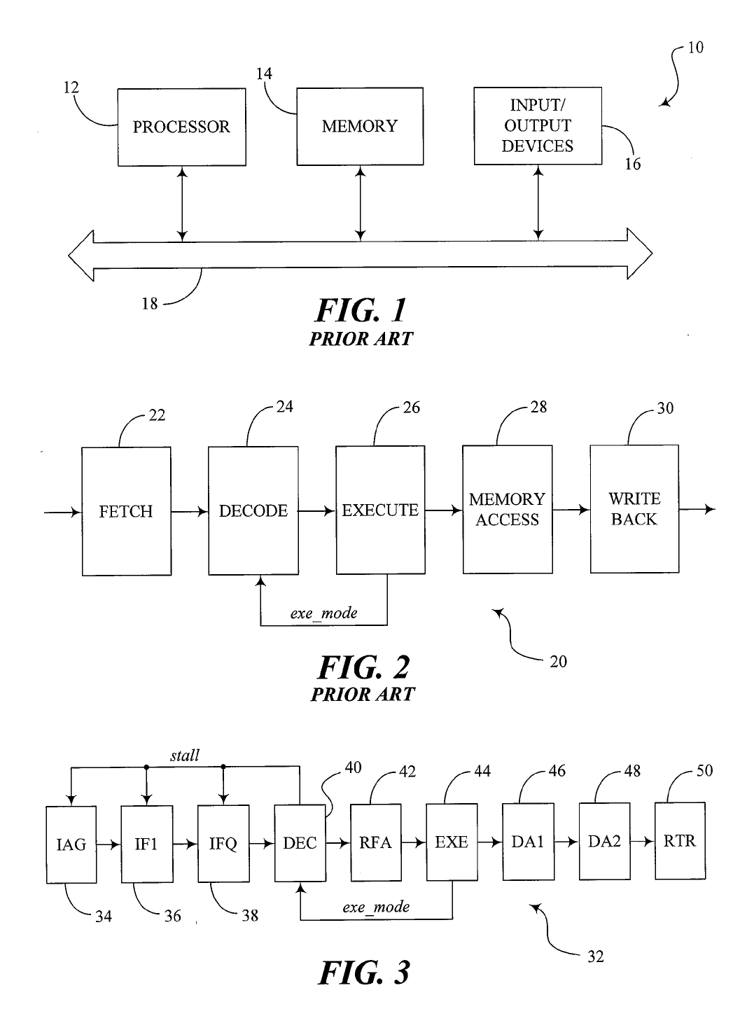

### DETAILED DESCRIPTION

FIG. 3 is a block diagram of an embodiment of a processor pipeline 32, which in this example contains nine stages. The stages of the pipeline 32 of FIG. 3 include an “instruction address generation” (IAG) stage 34, an “instruction fetch 1” (IF1) stage 36, an “instruction fetch queue” (IFQ) stage 38, a “decode” (DEC) stage 40, a “register file access” (RFA) stage 42, an “execute” (EXE) stage 44, a “data access 1” (DA1) stage 46, a “data access 2” (DA2) stage 48, and a “retirement” (RTR) stage 50. It should be noted, however, that the processor pipeline 32 may include more or fewer stages. Also, the names and functions of the stages may be altered if desired. The teachings of the present application primarily involve a decode stage and an execute stage, such as DEC stage 40 and EXE stage 44, within a processor pipeline. Based on alternative embodiments that may be conceived from an understanding of the present application, the concepts taught herein may be applied to the design of any suitable processor pipeline having a decode stage and execute stage, or other functionally similar stages.

Some reduced instruction set computer (RISC) processors use different modes to handle exceptions to the normal modes of operation. For example, when an instruction calls for an interrupt, the processor stops operation on the regularly running code to service the interrupt. The operational mode may be switched from a normal operational mode to an interrupt mode to service the interrupt. During this interrupt, the processor saves the next address of the regular code in a “link” register, which the processor returns to when the interrupt is complete. Registers common to the user mode and interrupt modes used to service the interrupt may be saved in memory having a starting address determined by a “stack” register. The same process may be used with the other exception modes. In this respect, each exception mode may have two dedicated registers for this purpose of returning to the normal operating condition of the previous mode.

After the initial stages 34, 36, and 38, an instruction encounters the DEC stage 40, RFA stage 42, EXE stage 44, DA1 stage 46, DA2 stage 48, and RTR stage 50, each of which can access a number of registers (not shown). The pipeline 32 may have access to about 32 registers, for example, in which 16 registers may be designated as general purpose registers. Also, about 16 other registers may be used during different operational modes of the processor. Depending on the mode in which the processor pipeline 32 operates, a certain group of the registers will be available. In this embodiment, the modes of operation include, for example, a “user” mode, “system” mode, “supervisor” (SVC) mode, “abort” (ABT) mode, “undefined” (UND) mode, “interrupt request” (IRQ) mode, and “fast interrupt request” (FIQ) mode. The user mode may be used as a normal operational mode and the IRQ mode may be used as a normal interrupt mode. It should be understood that other types of modes, such as various interrupt modes and the like, could be used depending on the particular processor design.

The processor may be configured such that registers R0-R15, for example, are used in both the user mode or system mode. Since the user mode and system mode share the same registers, switching between these modes does not change the availability of the registers. In the “exception” modes, such as the SVC, ABT, UND, and IRQ modes, however, some of these registers may not be available, although most of the same registers, e.g. R0-R12 and R15, may be available for use. However, instead of having access to registers R13 and R14, which are common to the user mode and system mode, the SVC mode can access R13_svc and R14_svc. Also, the ABT mode accesses R13_abt and R14_abt, the UND mode accesses R13_und and R14_und, and the IRQ mode accesses R13_irq and R14_irq. In this regard, only two of the 16 registers in these modes differ from the user mode or system mode, and utilization of the remaining 14 registers is not affected by a mode change.

The FIQ mode, on the other hand, may be configured in a slightly different manner. The FIQ mode accesses R0-R7 and R15, which are common to all the modes, but it also accesses R8_fiq through R14_fiq instead of registers R8 through R14. The registers R13_fiq and R14_fiq are used in a similar manner as the other exception modes. In addition, five additional registers R8_fiq through R12_fiq, for example, are designated for the FIQ mode for fast data access that does not require reading from or writing to external memory to save the user mode registers, thereby more quickly serving the fast interrupt. Also, it should be noted that the R13 and R14 registers may be used as the link and stack registers as described above.

As suggested above, an instruction occasionally enters the pipeline 32 that is an instruction to change modes. If this is the case, there is a possibility that some of the registers currently being used in the DEC 40 and RFA 42 stages, when the new mode is determined in the EXE stage 44, will not be available in the new mode. For instance, if the pipeline 32 is in the user mode and register R13 holds valid information, an instruction coming through the pipeline that changes from the user mode to another mode, e.g. the supervisor mode, which does not include register R13 in its set of registers, then a mode error occurs. In this case, the register R13 is inaccessible in the new mode when the mode is changed. The simple solution for handling a change of modes, as mentioned above, is to intentionally stall the pipeline, thereby preventing additional instructions from being received until the decode stage and execute stage are operating in the same mode. In this way, there would be very little chance, if any, of an error based on a different set of registers being available.

Referring again to FIG. 3, the EXE stage 44 is configured to send an “exe_mode” signal to the DEC stage indicating the mode at the EXE stage. If the DEC stage detects that an instruction may request the changing of modes to a new mode, the DEC stage sends a “stall” signal back to the IAG, IF1, and IFQ stages, causing these stages to wait until the mode change instruction is able to flow from the DEC stage 40 to the EXE stage 44 to determine the new mode. It should also be understood that in alternative embodiments, the teachings disclosed herein may apply to systems having different configurations of stages. Thus, the DEC stage 40 may send the stall signal to any or all of the stage(s) preceding the DEC stage 40.

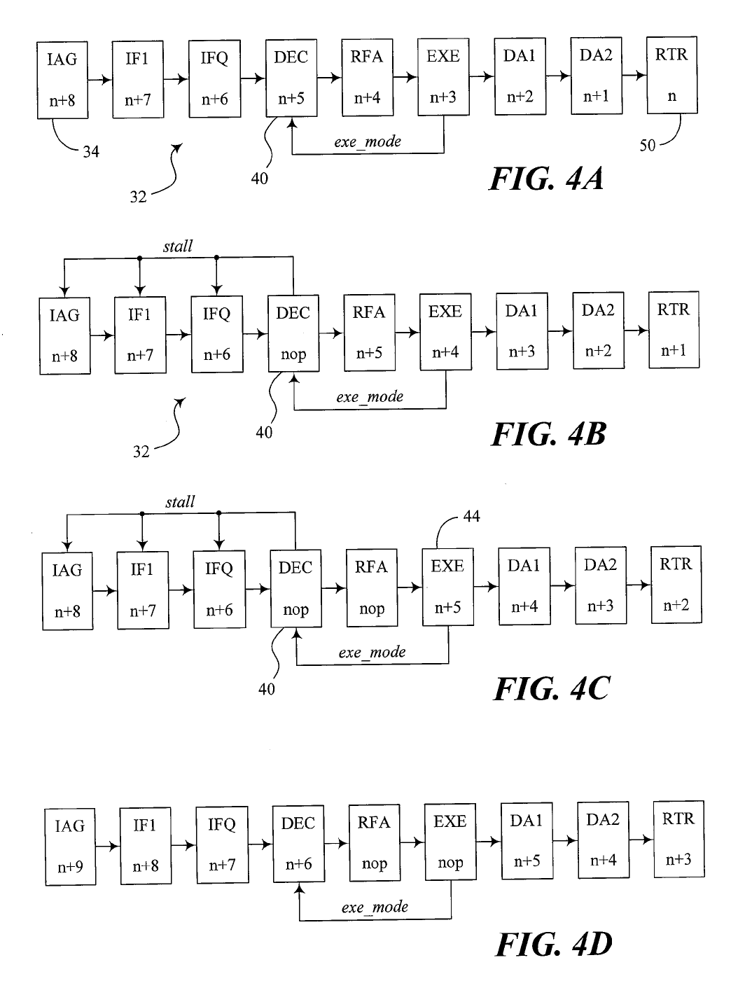

FIGS. 4A-4D illustrate an example of the flow of instructions through the processor pipeline 32 of FIG. 3. The instructions are labeled n, n+1, n+2, etc. In this example, instruction n has reached the RTR stage 50 at the end of the pipeline 32 and a new instruction n+8 is received in the IAG stage 34. When a mode change instruction, e.g. instruction n+5, is received in the DEC stage 40 in FIG. 4A, the DEC stage 40 detects whether there is a possible mode error. If so, the DEC stage 40 sends a stall signal to the previous stages IAG, IF1, and IFQ to stall these stages in the next clock cycle (FIG. 4B). As a result, instructions n+8, n+7, and n+6 remain in the IAG stage 34, IF1 stage 36, and IFQ stage 38, respectively. At this point, the DEC stage 40 generates a “no operation” (nop) signal to be passed through the pipeline 32. A nop signal, sometimes referred to as a bubble in the pipeline, does not carry any valid instruction and can be dropped or disregarded by the later stages of the pipeline 32.

In FIG. 4C, the DEC stage 40 stalls the previous stages for a second cycle and generates another nop signal. Also, the EXE stage 44 receives the n+5 instruction for changing modes and detects the new mode. Then, the EXE stage 44 sends the exe_mode signal to the DEC stage 40 indicating the new mode. At this point, the DEC stage 40 sets its mode to match the mode indicated by the exe_mode signal. Therefore, the stall signal is removed (FIG. 4D) and the previous stages continue to process more instructions. It can be seen from this example that the pipeline inserts two nop signals, which ultimately stalls or slows down the processor. The number of stalling cycles depends on the number of stages from the decode stage to the execute stage (including the decode stage and any intermediate stages between the decode stage and the execute stage). In this case, the pipeline is stalled for two cycles since the number of stages from the DEC stage 40 to the EXE stage 44 is two. By utilizing the embodiment of FIG. 3, the chance of a mode error caused by the inaccessibility of a set of registers is essentially eliminated by adding stalls whenever a mode change is detected.

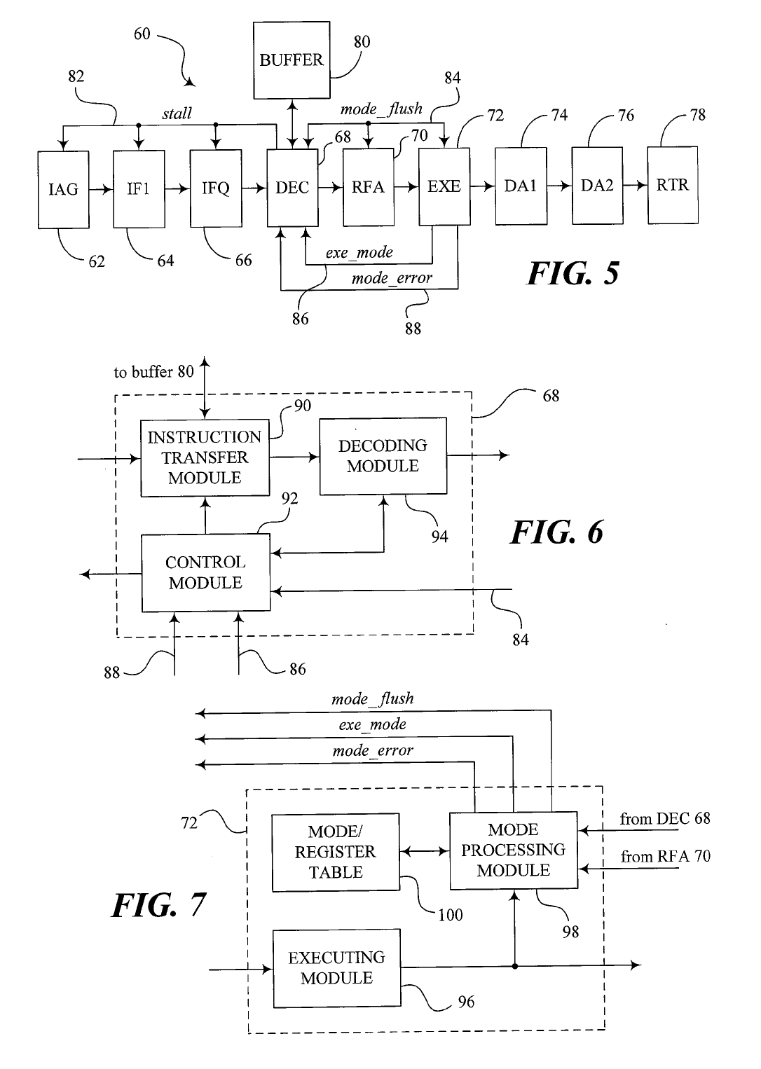

FIG. 5 is a block diagram of another embodiment of a processor pipeline 60 designed to reduce the number of stalls therein. In this preferred embodiment, the processor pipeline 60 includes an IAG stage 62, an IF1 stage 64, an IFQ stage 66, a DEC stage 68, an RFA stage 70, an EXE stage 72, a DA1 stage 74, a DA2 stage 76, and a RTR stage 78, which are similar stages to the embodiment of FIG. 3. However, the DEC stage 68 and EXE stage 72 include additional circuitry and/or logic, as described below, for reducing the number of stalls in the pipeline 60. Also, the processor pipeline 60 differs from FIG. 3 in that it includes a buffer 80 for storing a number of instructions from the DEC stage 68. The buffer 80, for example, may be configured as a first-in, first-out (FIFO) storage element. In addition, the buffer 80 may be configured, for example, to store two 64 bit entries, where each entry includes 32 bits for instruction and 32 bits for address information. In alternative embodiments, the buffer 80 may be configured to store a number of entries based on the number of stages from the decode stage to the execute stage (including the decode stage and any intermediate stage).

The DEC stage 68 may be configured to send a copy of each instruction for storage in the buffer 80. In this case, since the buffer 80 is configured to store only two instructions, when a third instruction is written in the buffer 80, the oldest instruction, which is no longer needed, is evicted or replaced by the new instruction. In this way, the last two instructions are available in the buffer 80 if needed. Alternatively, the DEC stage 68 may be configured to store the two instructions (assuming there are two stages from the decode stage to the execute stage) only following an instruction to change modes. In this embodiment, since instruction n+5 designates a mode change instruction, instructions n+6 and n+7 are stored in the buffer.

The DEC stage 68 is capable of sending a “stall” signal to the IAG stage 62, IF1 stage 64, and the IFQ stage 66 along communication line 82. The EXE stage 72 is capable of sending a “mode_flush” signal to the DEC stage 68 and RFA stage 70 along communication line 84. The EXE stage 72 is also capable of sending an “exe_mode” signal along communication line 86 and a “mode_error” signal along communication line 88 to the DEC stage 68.

In operation, the processor pipeline 60 is able to detect a change in mode. Also, the pipeline 60 detects whether or not the change in mode causes a mode change error, such as one in which a register being actively used in the previous mode would be inaccessible in the new mode. If a mode change error is not detected, the processor pipeline 60 does not interrupt or stall the flow of instructions, but allows the instructions to be processed normally. If a mode change error is detected, the processor pipeline 60 can stall the instruction flow and insert nop signals. Therefore, in contrast to previous solutions, the processor pipeline 60 does not automatically stall whenever a mode change is detected, but only stalls when the mode change would cause an error.

The processor pipeline 60 stores instructions from the DEC stage 68 into the buffer 80 and continues the flow as usual. The DEC stage 68 may store every instruction in the buffer 80 or alternatively may store only the instructions following a mode change instruction up to the point where the mode is the same in both the decode stage and execute stage. If the EXE stage 72 detects a change in mode that causes an error, then the EXE stage 72 sends the mode_error signal to the DEC stage 68 indicating there is a mode error. In response to the mode_error signal, the DEC stage 68 stalls the previous stages. Also, the EXE stage 72 sends the mode_flush signal to the DEC stage 68 and RFA stage 70 for flushing the contents of these stages and for inserting a nop signal therein. The function of flushing is performed since the processing of this pipeline 60 continues without stalling even after a decoded mode change is detected. And since the execute stage may determine, such as in this case, that the processing continued in the DEC stage 68 and RFA stage 70 according to an old mode that was found to provide invalid processing of the instructions. After the mode change instruction is able to flow to the EXE stage 72 for execution, the buffer 80 supplies the stored instructions back to the DEC stage 68 behind the nop signals in order that these stored instructions may be properly processed according to the new mode and corresponding register set. By utilizing this system, the same number of nop signals are inserted when an error does occur. However, as mentioned above, when the mode is changed and no mode error is detected, then the instructions are processed without delay and nop signals are not needed. As a result, no unnecessary stalls or bubbles are inserted into the pipeline 60.

FIG. 6 is a block diagram of an embodiment of the decode (DEC) stage 68 shown in FIG. 5. In this embodiment, the DEC stage 68 includes an instruction transfer module 90, a control module 92, and a decoding module 94. The instruction transfer module 90 is configured to receive instructions from the previous stage, e.g. the IFQ stage 66. The instruction transfer module 90 is also configured to write to and read from the buffer 80. The instruction transfer module 90 may include logic that is capable of selecting an instruction from the IFQ stage 66, when the pipeline 60 is not stalled, or from the buffer 80, when it is stalled. The instruction transfer module 90 then transfers the appropriate instruction from the selected source to the decoding module 94. The decoding module 94 may be configured to provide normal decoding functions for decoding the current instruction. In addition, the decoding module 94 may send a signal to the control module 92 indicating when an instruction to change modes has been decoded. The decoding module 94 may also send information regarding the decoded mode change instruction to the next stage, e.g. the RFA stage 70.

The control module 92 is configured to receive the signals along communication lines 86 and 88 from the EXE stage 72. The control module 92 may also receive a signal from the decoding module 94 indicating that a mode change instruction has been decoded. When the control module 92 receives an indication of a mode change from the decoding module 94, the control module 92 may instruct the instruction transfer module 90 to store the next two instructions in the buffer 80. This function may be optional since the instruction transfer module 90 may be configured to store each instruction in the buffer 80. In either way, the buffer 80 stores the latest two instructions from the DEC stage 68 when these instructions are needed. With respect to the embodiment where only the latest two instructions are stored, the control module 92 may be further configured to include logic or circuitry for detecting whether the mode determined in the EXE stage 72 as indicated by the exe_mode signal differs from the current mode as indicated by the decoding module 94. Also, as mentioned above, the buffer 80 may be designed to store more or fewer entries based on the number of stages from the decode stage to the execute stage (including the decode stage and any intermediate stage).

When a mode_error signal is received from the EXE stage 72 indicating that a mode error has occurred, the control module 92 instructs the decoding module 94 to replace the current instruction with a nop signal for transfer to the next stage. When the previous stages are stalled, the control module 92 further instructs the instruction transfer module 90 to select or read the instructions from the buffer 80 in the next two cycles for transfer to the decoding module 94. In this way the saved instructions can be processed by the decoding module 94 according to the newly detected mode. When instructions are read from the buffer 80, the control module 92 instructs the instruction transfer module 90 to select signals from the buffer 80 and sends a stall signal to the stages preceding the decode stage.

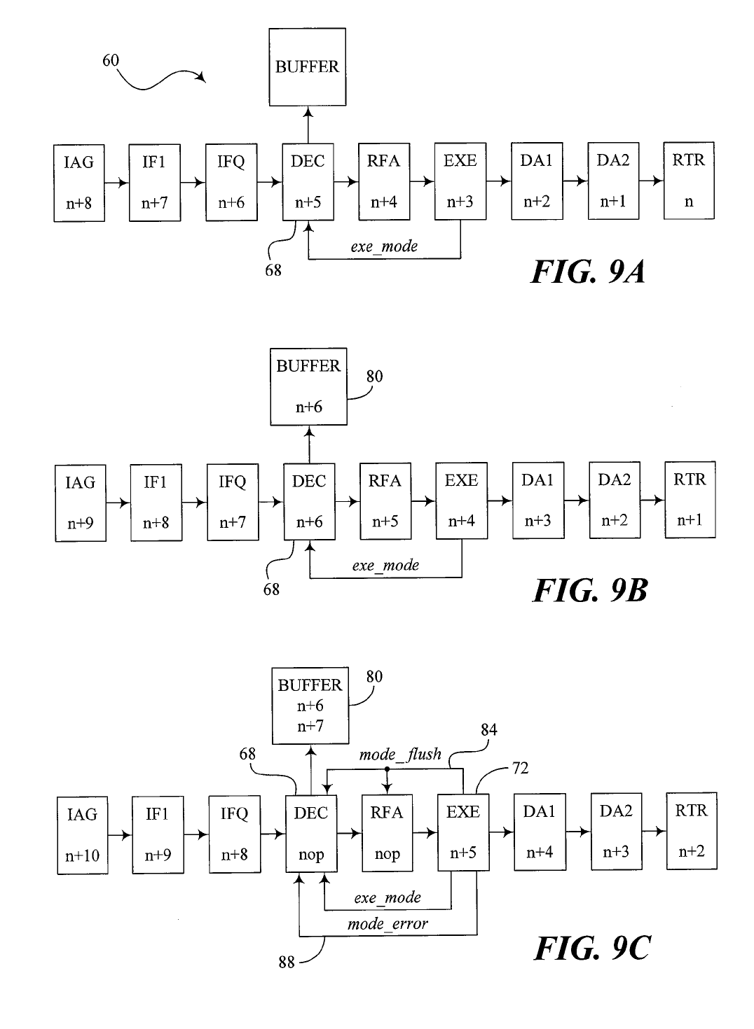

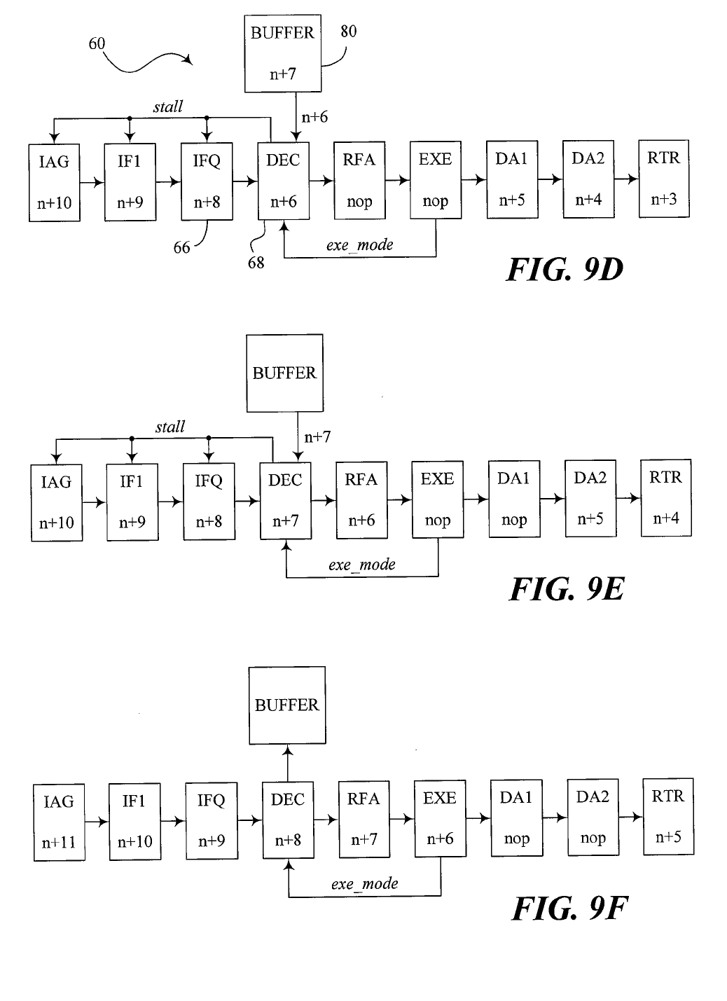

FIG. 7 is a block diagram of an embodiment of the execute (EXE) stage 72 shown in FIG. 5. In this embodiment, the EXE stage 72 includes an executing module 96, a mode processing module 98, and a mode/register table 100. The executing module 96 may be configured to provide normal execute functions for executing the current instruction and passing the executed instruction on to the next stage, e.g. the DA1 stage 74. The executed instruction is also sent to the mode processing module 98. If the instruction is a mode changing instruction, then the mode processing module 98 responds accordingly. The mode processing module 98 may be configured to store a mode from the previous clock cycle and compare the previous mode to the new mode. In addition, the mode processing module 98 may utilize a table, such as the mode/register table 100, and information about the current registers used in the DEC stage 68 and RFA stage 70 for determining whether or not the mode change causes a mode error. A mode error may be based, for instance, on a change of register accessibility that causes a conflict. The mode/register table 100 may include information concerning the correlation between modes and the registers accessible in each mode. If the mode processing module 98 determines that the mode change causes an error, then this module sends the mode_error signal to the DEC stage 68. Also, with an error, the mode processing module 98 sends the mode_flush signal to the stages from the decode stage up to the execute stage for flushing the instruction from these stages. In this case, a nop signal is placed in the flushed stages since the flushed information is based on the faulty assumption that the mode change will not cause an error in register accessibility. As mentioned above with respect to FIG. 6, the mode_error and mode_flush signals are received in the DEC stage 68 for processing an error condition. Further details of processing during a mode error are described with respect to FIG. 9 below.

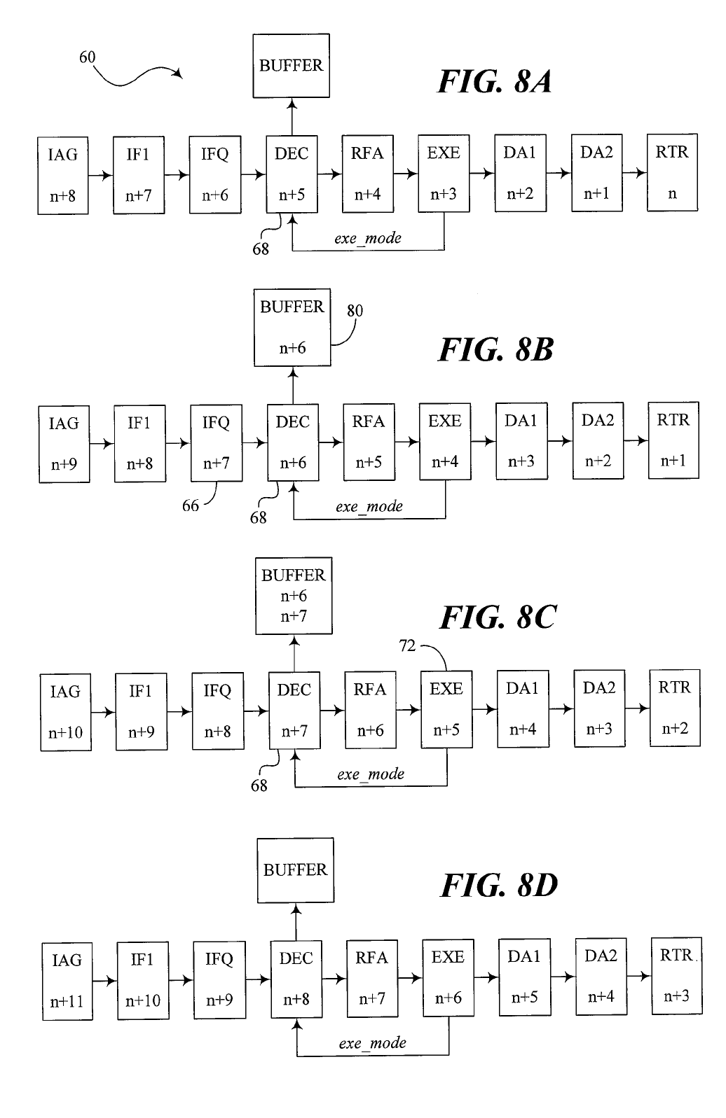

FIGS. 8A-8D illustrate an example of instructions flowing through the processor pipeline 60 of FIG. 5 when a change of mode does not cause a mode error. In this example, the DEC stage 68 in FIG. 8A detects an instruction n+5 for changing the operational mode of the pipeline 60. In FIG. 8B, illustrating the next clock cycle, the DEC stage 68 receives instruction n+6 from the IFQ stage 66 and stores this instruction in the buffer 80. Also, the DEC stage 68 does not stall the previous stages, but processes instruction n+6 as normal. In FIG. 8C, the DEC stage 68 stores instruction n+7 in the buffer 80. During this clock cycle, the EXE stage 72 detects whether the change in mode makes one or more registers inaccessible, thereby causing a mode error. In this example of FIG. 8, the EXE stage 72 determines that the mode change does not cause an error and the pipeline is allowed to flow the instructions without stalling (FIG. 8D).

It should be noted that the pipeline 60 essentially makes an assumption that a mode change will not cause a mode error and that processing can continue without delay. Since most of the registers utilized in one mode are the same as the registers utilized in another mode, it is more likely that a change of modes will not cause an error. However, as a back up, the pipeline 60 stores the instructions in the buffer 80 in case the assumption is false and the mode change does cause an error. Even when an error is detected, the pipeline 60 can recover and only stall the flow for the same number of stalls as previous solutions. Recovery of the instructions, which involves the buffer 80, is described below with respect to FIGS. 9A-9F.

FIGS. 9A-9F illustrate an example of instructions flowing through the processor pipeline 60 of FIG. 5 when a change of mode causes a mode error, such as the inaccessibility of one or more active registers when the operational mode of the pipeline 60 changes. FIG. 9A is similar to FIG. 8A in that an instruction n+5 for changing modes is received in the DEC stage 68. Also, FIG. 9B is similar to FIG. 8B where the buffer 80 stores instruction n+6 from the DEC stage 68 and the flow of instruction continues without stalling. In FIG. 9C, however, the buffer 80 stores instruction n+7 and the EXE stage 72 detects an error caused by the mode change. In this example, the EXE stage 72 sends a mode_error signal along communication line 88 indicating that an error has occurred. In response, the operation of the pipeline 60 branches to a recovery state to recover the instructions that were improperly processed by the DEC stage 68 and RFA stage 70 because of a register conflict with the old mode.

When the EXE stage 72 detects that the mode change instruction n+5 changes from one mode to another so as to cause an error, the EXE stage 72 provides signals to earlier stages to recover the pipeline 60. The EXE stage 72 flushes the instructions in the DEC and RFA stages using the mode_flush signal. Since the instructions n+7 and n+6 in these stages have been processed based on an invalid mode, the mode_flush signal instructs the DEC and RFA stages to replace these instructions with nop signals. The EXE stage 72 also sends the mode_error signal along line 88 to the DEC stage 68. This signal instructs the DEC stage 68 to stall the previous stages on the next clock cycle (FIG. 9D).

In FIG. 9D, the DEC stage 68 stalls the previous stages and, instead of receiving an instruction from the IFQ stage 66, receives instruction n+6 from the buffer 80. In this respect, it can be understood that the buffer 80 is configured to supply the instruction n+6 stored two cycles earlier (the first-in instruction). The DEC stage 68 processes instruction n+6 accordingly. The nop signals from DEC and RFA in the previous cycle are passed through the pipeline 60. Again in FIG. 9E, the DEC stage stalls the previous stages and receives instruction n+7 from the buffer 80. At this point, the pipeline 60 is recovered and the instructions n+6 and n+7 are processed correctly according to the new mode. In FIG. 9F, the pipeline continues as normal and the stall signal is removed to allow the IAG, IF1, and IFQ stages to process new instructions.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

I claim:

1. A processor pipeline comprising:
a fetch stage configured to fetch instructions to be processed in the processor pipeline;
a decode stage configured to decode the fetched instructions; and
an execute stage configured to execute the decoded instructions;
wherein the decode stage is configured to store instructions in a temporary buffer before the instructions are decoded.

2. The processor pipeline of claim 1, wherein the decode stage is further configured to stall the fetch stage when the execute stage detects an error caused by a change in the operational mode of the processor pipeline.

3. The processor pipeline of claim 2, wherein the execute stage detects the error when one or more registers being used in a current operational mode are determined to be inaccessible in a new operational mode.

4. The processor pipeline of claim 2, further comprising a plurality of stages preceding the decode stage, wherein the decode stage stalls the preceding stages when the error is detected.

5. The processor pipeline of claim 2, wherein the execute stage causes the decode stage to generate a “no operation” (nop) signal when the error related to the change of the operational mode of the processor pipeline is detected.

6. The processor pipeline of claim 5, further comprising at least one stage positioned between the decode stage and the execute stage, wherein the execute stage is further configured to cause the stages positioned between the decode stage and execute stage to generate a nop signal when the error is detected.

7. The processor pipeline of claim 1, wherein the decode stage is further configured to decode instructions from either the fetch stage or the temporary buffer.

8. The processor pipeline of claim 7, wherein the decode stage receives instructions from the temporary buffer when the stages before the decode stage are stalled.

9. The processor pipeline of claim 1, wherein, when an instruction to change the operational mode of the processor pipeline does not cause an error resulting from the availability of registers with respect to the operational modes, then the processor pipeline is allowed to continue processing instructions without stalls.

10. A processor comprising:
a pipeline including at least a decode stage and an execute stage; and
a temporary buffer, in communication with the decode stage, for temporarily storing instructions;
wherein the decode stage is configured to store a first instruction in the temporary buffer, and wherein the decode stage is further configured to decode the first instruction.

11. The processor of claim 10, wherein the pipeline is capable of processing a number of instructions without stalling, even when a change in the operational mode of the pipeline is detected.

12. The processor of claim 11, wherein the pipeline processes the instructions without stalling when the mode change does not require accessibility of a register that is unavailable in the new mode.

13. The processor of claim 10, wherein the decode stage comprises:
an instruction transfer module for transferring instructions;
a decoding module for decoding instructions; and
a control module;
wherein the instruction transfer module is configured to select whether instructions transferred to the decoding module are received from a stage preceding the decode stage or from the temporary buffer.

14. The processor of claim 10, wherein the execute stage comprises:
an executing module for executing instructions;
a mode processing module for processing the status of operational modes; and
a mode/register table for storing information regarding the correlation between operational modes and sets of registers.

15. A method for processing instructions in a processor pipeline, the method comprising:
decoding an instruction to change the operational mode of the processor pipeline;
storing at least one instruction after the mode change instruction; and
detecting whether the mode change instruction causes a mode change error.

16. The method of claim 15, further comprising decoding, with stalling, at least one instruction after the mode change instruction.

17. The method of claim 15, further comprising disregarding the at least one stored instruction when no mode change error is detected and continuing to decode instructions without stalling.

18. The method of claim 15, wherein, when a mode change error is detected, the method further comprises:
stalling the stage preceding a decode stage; and
decoding the at least one stored instruction.

19. The method of claim 18, wherein the stage preceding the decode stage is stalled a number of cycles equal to the number of stage from the decode stage to an execute stage.
